(19) United States
(12) Patent Application Publication
(10) Pub. No.: US 2009/0092843 A1
(43) Pub. Date: Apr. 9, 2009

(54) PROCESS FOR MODIFYING A SILICONE RUBBER SURFACE

(76) Inventors: Joachim Arlt, Frankenberg (DE); Edgar Quandt, Gattendorf (DE)

Correspondence Address: BROWDY AND NEIMARK, P.L.L.C.;624 NINTH STREET, NW, SUITE 300, WASHINGTON, DC, 20001-5303, US

(21) Appl. No.: 11/914,940

(22) PCT Filed: May 16, 2006
(86) PCT No.: PCT/EP2006/004596

§ 371 Date: Nov. 19, 2007

(30) Foreign Application Priority Data
May 19, 2005 (DE) 10 2005 023 017.2
May 19, 2005 (DE) 10 2005 023 018.0

(51) Int. Cl. B32B 25/20; B05D 1/00

(52) U.S. Cl. 428/447; 427/223

(57) ABSTRACT

The process for modifying a silicone rubber surface by coating with a functional layer is characterised in that a silicate-containing functional layer is deposited from a flame on the silicone rubber surface, as a result of which the surface is modified in such a way that it has a very low adhesion or tackiness.

The invention relates to a process for modifying a silicone rubber surface according to the preamble of claim 1. The invention also relates to an article made of silicone rubber, the surface of which is modified according to this process.

Due to its extremely favourable property profile and its extensive modification ability, silicone rubber is used in many different applications. An important field of application is the medical sector and, in particular, the application as catheter tubes.

As a condition of formulation, the surfaces of silicone rubber are extremely “tacky” or they have a high adhesion tendency. This has a disadvantageous effect in the production of articles as well as in the application thereof. In most cases therefore, this tackiness is reduced by a subsequent treatment of the surface which is generally carried out by applying separating agents, for example based on oils or by powdering with talcum.

It is disadvantageous here that not only is this subsequent treatment cost-intensive, but also, above all for applications in the field of medicine, that the oils or the talcum complicate the production under clean room conditions, or make it completely impossible. Moreover, in the case of catheters, lubricants are also used.

An attempt at overcoming this disadvantage is described in DE 198 39 996 B4 where a coating is deposited on a polymeric surface by a plasma polymerisation process. However, a disadvantage of this attempt is that this process is basically carried out under vacuum and is therefore extremely cost-intensive and, moreover, is only suitable for tubes. Coating mouldings is not possible according to DE 198 39 996 B4.

DD 253257 A1, for example, describes a pyrolysis process under atmospheric conditions for modifying the surface of tubes under normal pressure. In this case, an inner and/or outer coating is applied to a metal tube by an SiOx-C adhesion promoter layer system, thus ensuring an improved adhesion of plastics material coatings on the tube.

A disadvantage, however, is that for this process, an additional temperature control system is required in the form of a high or medium frequency coil and a silane application system is required using a spray system, a sponge, felt or scraper brush.

DE 199 05 697 A1 describes a flame coating of a material surface having a firmly bonded silicate layer. The silicate layer serves as an intermediate layer for an adhesive silane layer which is to be applied subsequently and onto which in turn an organic adhesive or a lacquer is applied. An alkane is used as the fuel gas in the flame coating process. DD 256 151 A1 is discussed in DE 199 05 697 A1. In connection with DD 256 151 A1, it is stated in DE 199 05 697 A1 that a content of 2% tetraethoxysilane is used in the fuel gas in the process according to DD 256 151 A1.

DE 197 48 606 A1 describes a plasma process for producing superficially hydrophilised silicone elastomers. The layer thicknesses are in the region of 10 μm.

US 2002/0098364 A1 and WO 94/111 118 A1 describe plasma coating processes.

The object of the present invention is to provide a simple, cost-effective process which takes place under normal pressure, is equally suitable for coating profiles and mouldings, may be easily integrated into the production line of silicone rubber articles and produces a silicone rubber surface having a very low adhesion or tackiness.

A further object of the invention is to provide an article which has a correspondingly modified silicone rubber surface having a very low adhesion or tackiness.

The object in respect of the process could be achieved by a process having the features of claim 1.

Preferred embodiments and developments are stated in the subclaims.

The process according to the invention pyrolytically deposits on the silicone rubber surface to be coated, from a layer-forming silicon organic compound, a preferably 40 to 100 nm thick layer which contains silicate and in particular has the approximate composition [SiO₂(OH)ₙ].

This layer may be deposited under atmospheric pressure, but it is also possible for it to be deposited under other pressures.

This silanol/siloxane layer naturally adheres in an outstanding manner to silicone rubber surfaces, being almost free from defects.

The applied layer modifies the silicone rubber surface in such a way that it has only a very low adhesion or tackiness.

A gas composition according to claim 2 has been Found to be particularly advantageous for the production of a substantially adhesion-free functional layer. It was surprising in this respect that it was possible to work with such small quantities of layer-forming gases.

Distances between the flame cone and the surface of the silicone rubber according to claim 10 as well as guide relative speeds according to claim 11 have proved to be particularly suitable for the efficient deposition of the silicate-containing functional layer.

Depending on the shape of the basic body of an article on which the functional layer is to be deposited, nozzle head embodiments according to claim 12 have proved to be advantageous.

A coating within a production line for the article according to claim 13 is particularly efficient.

As far as the article is concerned, the object is achieved by the combination of features of claim 14.

The advantages of the article correspond to those mentioned above with reference to the production process for the functional layer according to claims 1 to 13.

The article according to the invention is used as a tube particularly in medical technology, in particular as a catheter tube or a drainage tube or an ECC standard tube, as a connector, a seal, a closing element, a bag or as another medical moulding.

Alternatively it is possible to use the article according to the invention as a hose, a profile, a belt or a cord in applications in heating cabinets, laboratory equipment, kitchen equipment, for example as oven seals, and in auto-mobile technology.

Articles made of silicone rubber have a surface which is modified according to the process of the invention and have only a very low adhesion or tackiness and may thus be advantageously managed in the production process without further surface treatments and used in the applications thereof.

The invention will be described in detail below with respect to the following figures:

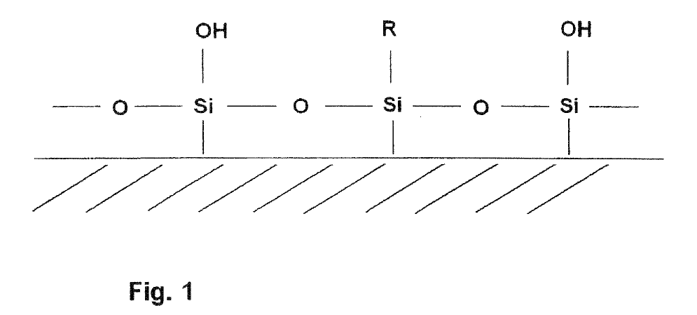

FIG. 1 shows the approximate composition of the deposited silanol/siloxane layer;

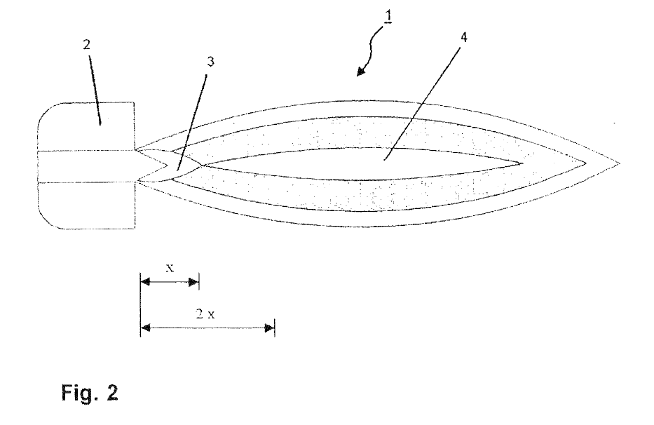

FIG. 2 shows a schematic diagram of a flame with the oxidising region and the reducing region;

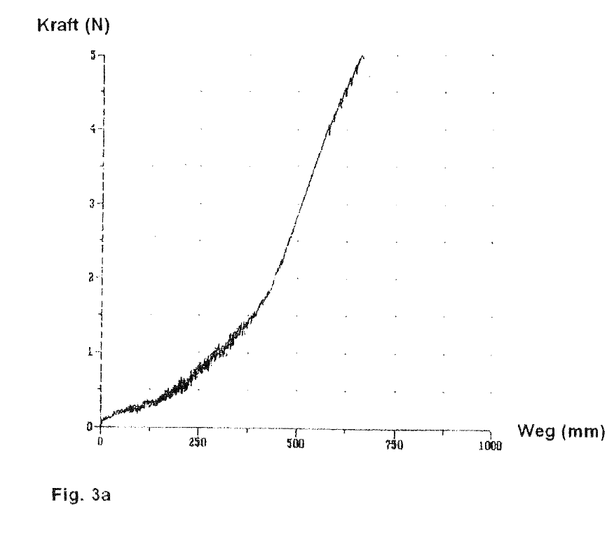

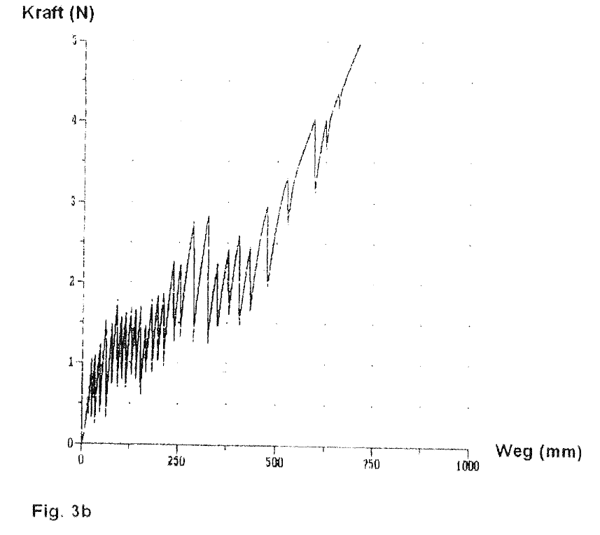

FIG. 3a, 3b show graphs of the results of a friction test as a stress-strain diagram on an embodiment of the invention, FIG. 3a illustrating the result with the layer applied to the silicone rubber surface, FIG. 3b showing the result without the corresponding layer.

FIG. 1 shows the approximate composition of the silanol/siloxane layer deposited by the flame under atmospheric pressure.

FIG. 2 shows a schematic diagram of a flame 1 with the oxidising region and the reducing region.

The flame is produced by a nozzle head 2.

The flame 1 forms an oxidising zone 3 and a reducing zone 4.
A fuel gas,
air as the oxygen-supplying gas and
a layer-forming gas
   are supplied to the nozzle head 2 from a gas feed unit.

Suitable fuel gases include propane, butane, methane or natural gas. However, hydrogen may also be used as a fuel gas.

Instead of air, oxygen or an oxygen-containing gas mixture may also be fed into the nozzle head.

Hexamethyldisiloxane (HMDSO) or tetramethoxysilane or tetraethoxysilane or another alkoxysilane or trimethylsilane may be used as a layer-forming gas. It is also possible to use various cyclic silane compounds. For this purpose, liquid compounds are converted into the gas phase using suitable methods.

The throughputs of fuel gas and air are to be selected in such a way that a light blue flame colour which is as intensive as possible is adjusted. A fuel gas to air ratio of from 1:15 to 1:25, preferably of 1:20, in terms of gas quantities, has proved to be particularly suitable.

Only a very small proportion of the layer-forming gas is added to the mixture of fuel gas and air selected in this way.

A proportion of the layer-forming gas of approximately 0.1 to 1%, preferably 0.2 to 0.4% of the total gas flow is used.

When the flame 1 has been ignited, the thermal output thereof on the one hand and the distance of the flame cone from the surface to be coated on the other hand are selected in such a way that the substrate is not thermally damaged.

In this context, the flame cone is defined as the boundary between the oxidising zone 3 and the reducing zone 4 of the flame 1.

To achieve a firmly adhesive, tight coating, the silicone rubber surface is to be positioned inside the reducing zone 4 close to the flame cone.

If the distance of nozzle tip to flame cone tip is defined as x, the surface is to be positioned at a distance of x to 2x, preferably x to 10.5x from the tip of the nozzle.

For coating profile-shaped elements, the nozzle head expediently consists of a ring nozzle, the individual nozzles of which are positioned on the inside thereof, i.e. towards the substrate to be coated.

Profiles may be coated in a particularly advantageous manner if the nozzle head is constructed in such a way that it has a conically slanting region into which the profile runs, nozzles for producing the flame being positioned in this region. The included angle of the cone may be from 10° to 80°. Consequently, the silicate-containing functional layer is deposited in a particularly homogeneous and uniform manner.

If sheet-like or approximately sheet-like parts or mouldings formed in a correspondingly complex manner are to be coated, the nozzle head consists of a linear or an approximately linear arrangement of individual nozzles.

To apply the coating and to prevent the coating flame from overheating the substrate, a relative movement between the nozzle head and the substrate may be necessary.

If profile elements are to be coated, they are usually guided mechanically over rollers or the like and moved past the flame and in this case the nozzle head is fixed.

If mouldings which have a complex geometry are to be coated, the part to be coated may expediently be fixed and the nozzle head may be moved past the surface of the moulding in a suitable manner, for example by a computer-controlled arm.

According to the invention, the relative advance rate of the coating flame in relation to the surface of the moulding of silicone rubber to be coated is preferably 10 to 20 m/min, with limiting values of at least 1 and at most 50 m/min.

It may also be provided to repeat the coating operation several times in succession and to thereby produce multi-layered coatings. This may be carried out by repeatedly passing a flame over the substrate or by arranging a plurality of ring nozzles when profiles are coated.

A particular advantage of the process according to the invention is the possibility of being able to integrate the process in the extrusion line for the production of tubes, pipes or profiles so that it is possible to carry out a cost-effective inline coating operation.

The process according to the invention for modifying silicone rubber surfaces crucially changes the friction and adhesion characteristic of the surface.

Test curves show that the coating significantly changes the sliding behaviour and the slip-stick effect occurring on the uncoated substrate is practically eliminated.

Likewise, the modification drastically reduces the tendency of adhesive bonding to the silicone surface.

The coating of a tube made of silicone rubber to be used as a medical catheter is described in the following with reference to an embodiment.

### EXAMPLE

In an extrusion line, a tube having dimensions of 2.7 mm×0.6 mm is extruded at a rate of 20 m/min from an HTC (high temperature cross-linking) silicone rubber mixture for a Shore hardness of A 60 and the extruded blank is then vulcanised to produce the elastomer tube in an annealing tunnel at an internal temperature of 200° C.

After emerging from the annealing tunnel, the silicone rubber tube cools to a temperature of approximately 100° C. in the line, is then guided over a set of rollers through a ring nozzle where it is coated and then rolled on a drum.

The following process parameters were used:
The reaction gas has the following composition:

| | |
|---|---|
| HMDSO | throughput 0.47 l/min |
| Propane gas | throughput 8 l/min |
| Air | throughput 160 l/min |

Distance from flame cone to surface: 10-20 mm (range due to the oblique arrangement of the nozzles).

Testing the silicone rubber tube coated according to the invention produced the following results:

### 1. Friction Test

FIG. 3a, 3b are graphs of the results of the friction test of the surface of the tube provided with the sliding layer according to the invention (FIG. 3a) compared to the untreated tube surface (FIG. 3b) as stress-strain diagrams. The test curves show that the coating significantly changes the sliding behaviour and the slip-stick effect occurring on the uncoated substrate is practically eliminated.

For this purpose, the “knot test” was carried out. In this test, the tube is twisted to form a knot, the ends of the knot are clamped in a tension test machine and the ends of the tube are pulled apart. Consequently, the knot is tightened and one surface rubs on another surface of the tube. The illustrated stress-strain diagrams are determined therefrom.

In the “knot test”, the tube had an external diameter of 6 mm with a wall thickness of 1 mm. The total length of the piece of tube used was 450 mm the knot was located in the in middle of the piece of tube. A clamping length in the tension test machine of 200 mm was selected. At the start of measuring, the tube was stretched with the knot in the tension test machine, but without tensile stress. The knot was tightened at a defined velocity v=50 mm/min. In the process, the tensile force between the clamped ends of the tube was measured as a function of the tensile deformation and shown in the diagrams in FIGS. 3a and 3b.

### 2. Further Characteristics

The medical tests relevant to catheters produced the following results:
the applied siloxane/silanol layer is pyrogen-free and does not exhibit cytotoxicity or haemolysis,
in the conventional sterilisation processes, namely
   superheated steam sterilisation at 121° C.
   ETO gas at max. 60° C.
   gamma radiation at 40 kGy
the slidability is not significantly impaired, nor is there
any process-induced particle contamination,
any change in the slidability of the layer after rubbing the surface of the tube with disinfectant (70% isopropanol solution).

1-15. (canceled)

16. A process for modifying a silicone rubber surface by coating with a functional layer, wherein a silicate-containing functional layer is deposited from a flame on the silicone rubber surface, as a result of which the surface is modified in such a way that it has a very low adhesion or tackiness.

17. A process according to claim 1, wherein the following gas compositions are used to generate the flame:
Fuel gas to air ratio of from 1:15 to 1:25, in terms of the quantities of gas, and
layer-forming gas content of from 0.1 to 1% of the total gas flow.

18. A process according to claim 16, wherein a functional layer having a thickness of from 40 to 100 nm is deposited.

19. A process according to claim 16, wherein propane or butane or natural gas or methane or hydrogen or a mixture of the aforementioned gases is used as the fuel gas.

20. A process according to claim 16, wherein air or oxygen or a gas mixture containing oxygen is used.

21. A process according to claim 16, wherein one of the group of
hexamethyldisiloxane (HMDSO),
tetramethoxysilane,
tetraethoxysilane
another alkoxysilane,
trimethylsilane,
a cyclic silane compound
is used as the layer-forming gas.

22. A process according to claim 17, wherein the fuel gas to air ratio is preferably selected at 1:20 in terms of the quantities of gas.

23. A process according to claim 17, wherein the proportion of the layer-forming gas is preferably selected at 0.2 to 0.4% of the total gas flow.

24. A process according to claim 16, wherein the silicate-containing functional layer is deposited under atmospheric pressure.

25. A process according to claim 16, wherein the distance of the flame cone to silicone rubber surface is selected in such a way that it satisfies the relationship: Distance in the range of from x to 2x, wherein x represents the distance from the tip of the nozzle to the tip of the flame cone.

26. A process according to claim 25, wherein the distance of the flame cone to silicone rubber surface is selected in such a way that it satisfies the relationship: Distance in the range of from x to 1.5x, wherein x represents the distance from the tip of the nozzle to the tip of the flame cone.

27. A process according to claim 16, wherein the flame is moved over the silicone rubber surface at a rate of between 1 and 50 m/min.

28. A process according to claim 27, wherein the flame is moved over the silicone rubber surface at a rate of between 10 and 20 m/min.

29. A process according to claim 16, wherein the flame is produced by a nozzle head, the nozzle head having a form according to one of the group of being
annular,
linear,
approximately linear.

30. A process according to claim 16, wherein the silicone rubber surface of a moulding is coated in the moulding production line.

31. An article made of silicone rubber having a modified surface in the form of a functional layer, produced by a process according to claim 16.

32. An article according to claim 24, wherein the functional layer is formed as a silanol/siloxane layer.
